(19) United States
(12) Patent Application Publication
(10) Pub. No.: US 2023/0365056 A1
(43) Pub. Date: Nov. 16, 2023

(54) AMBIENCE ILLUMINATED HANDLE

(71) Applicant: FKT KOLTUK SISTEMLERI ÜRETIM VE DAGITIM SANAYI VE TICARET ANONIM SIRKETI, Nilüfer (TR)

(72) Inventor: Emin SEZGIN, Nilüfer (TR)

(21) Appl. No.: 18/315,780

(22) Filed: May 11, 2023

(30) Foreign Application Priority Data
May 11, 2022 (TR) 2022/007677

(51) Int. Cl. B60Q 3/233

(52) U.S. Cl. CPC B60Q 3/233

(57) ABSTRACT

Disclosed is an ambient illuminated handle that is developed to be used in passenger seats in all vehicles used for passenger transportation, especially in M1, M2, M3, VIP travel buses and minibuses, and rail systems. The handle increases vehicle design and comfort, and has lighting connected to the handle so that the passengers can easily see the handle in the dark and to increase the interior aesthetics of the vehicles used in passenger transportation.

### CROSS-REFERENCE TO RELATED APPLICATIONS

Not applicable.

### BACKGROUND OF THE INVENTION

### 1. Field of the Invention

The present invention relates to an ambient illuminated handle that is developed to be used in M1, M2, M3, VIP travel buses and minibuses and rail system seats, increases vehicle design and comfort.

### 2. Description of Related Art Including Information Disclosed Under 37 CFR 1.97 And 37 CFR 1.98

Today, vehicle classes are divided into L-class, M-class, N-class, and the like. M class is divided into three as M1, M2 and M3. M class vehicle classes are motor vehicles with at least four wheels and are used for passenger transport. M1 class is a motor vehicle used for passenger transport and has a maximum of 9 seats, including the driver. M2 class is a motor vehicle used for the transport of passengers, with more than 9 seats, including the driver, and with a maximum weight not exceeding 5 tons. M3 class is a motor vehicle used for the transport of passengers, with more than 9 seats, including the driver, and with a maximum weight exceeding 5 tons.

While many applications are made today for a luxurious appearance in passenger cars, studies to improve the aesthetic appearance especially in vehicles used for passenger transportation focus on areas such as changing upholstery fabrics, improving the seat structure, changing the distance between seats. The trays and screens added to the seats over time are intended to increase passenger comfort. Another improvement made in passenger transport vehicles is the floor lighting added to the middle hall. These lightings aim to enable the passengers to walk in the corridor comfortably at night when the ambient light is low, rather than to improve the aesthetic appearance. Ambient lighting used in passenger vehicles is not applied to vehicles carrying passengers. Although its scope and shape vary from model to model, ambience lighting generally illuminates the interior of the vehicle with the help of the LED lights on the driver and front passenger side door interior decorations, front foot area and front roof lighting.

One of the studies on the configuration of the interior ambience lighting system and making the interior of the vehicle more aesthetic is the invention that is the subject of the patent application numbered CN200910168613. The invention provides an ambience lighting system in the vehicle. The system consists of a lighting module and a central controller. The lighting module is configured for at least one light-emitting diode (LED) arrangement to provide electrical connection to the vehicle and to show the desired ambient color and intensity. The central controller is configured to transmit an inspection command on a data communication bus to the lighting module to determine whether the lighting module is electrically connected to the vehicle.

Another study is the invention subject to the patent numbered TR 2018/20735. The invention relates to a lighting system located at the back of the seats in passenger transport vehicles and providing focused lighting to the desired location.

Another study is the invention subject to patent number TR 2016/06575. A lighting system of a vehicle headrest is provided here. The lighting system includes a support that attaches to a headrest at a first end and is removable attached to a seatback at the opposite end. A light source is located on the headrest. A first photoluminescent structure is placed within the illumination system and is configured to glow in response to excitation by the light source. The light source may contain multiple printed LEDs that implement a precise configuration.

As a result, the requirement for an ambience illuminated handle which eliminates the abovementioned problems and the insufficiency of the current solutions makes it necessary to make a development in the relevant technical field.

### BRIEF SUMMARY OF THE INVENTION

The present invention relates to an ambient illuminated handle that meets the above-mentioned requirements, eliminates all disadvantages, and brings some additional advantages, is developed to be used in M1, M2, M3, VIP travel buses and minibuses and rail system seats, increases vehicle design and comfort.

The aim of the invention based on the state of the art is to contribute to the existing vehicle design and comfort by using it on the M1, M2, M3 and VIP travel buses and minibuses and on the rail system seats with the help of the ambiance illuminated handle.

The aim of the present invention is to improve the comfort image of the vehicle and to ensure that it is preferred by the passenger, with the help of the adjustment of the lighting color of the ambient illuminated handle.

The structural and characteristic features of the present invention will be understood clearly by the following drawings and the detailed description made with reference to these drawings and therefore the evaluation shall be made by taking these figures and the detailed description into consideration.

### BRIEF DESCRIPTION OF THE SEVERAL VIEWS OF THE DRAWINGS

In order to understand the advantages of the present invention with its structure and additional elements, it shall be evaluated with the following defined figures.

FIG. 1 is a schematic overview of the ambience illuminated handle in assembled state.

FIG. 2 is a schematic overview of the ambience illuminated handle in disassembled state.

FIG. 3 is a schematic overview of the ambience illuminated handle on the seat.

### REFERENCE NUMBERS

100. Ambience illuminated handle
110. Cover
111. Handle connecting threads
120. Handle
121. Connecting element
122. Seat connecting thread
130. Seat connecting body
131. Handle slot
140. Lighting
200. Passenger seat

### DETAILED DESCRIPTION OF THE INVENTION

In this detailed description, the inventive ambient illuminated handle (100) that is developed to be used in passenger seats (200) in all vehicles used for passenger transportation, especially in M1, M2, M3, VIP travel buses and minibuses, and rail system, increases vehicle design and comfort is described only for clarifying the subject matter illustratively and in a manner such that no limiting effect is created.

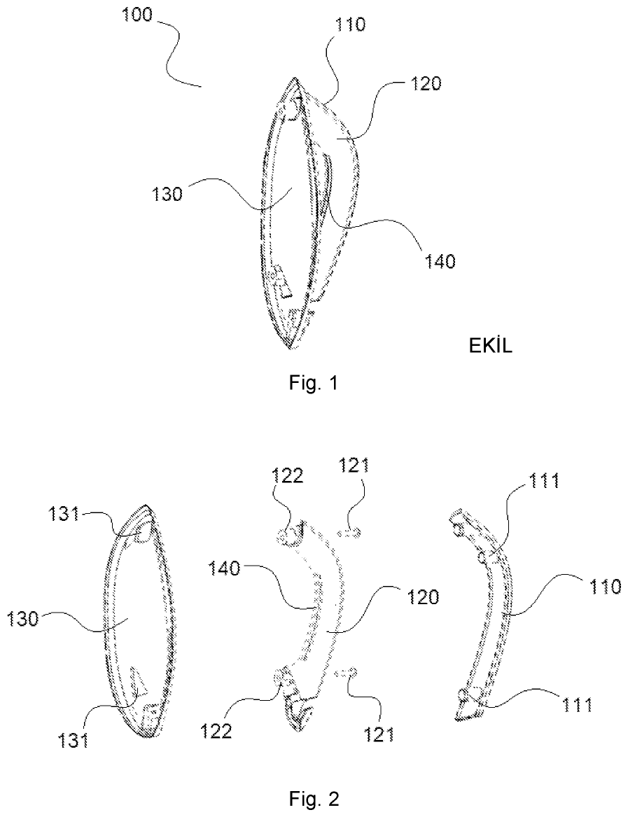

The ambience illuminated handle (100) shown in FIG. 1 consists of LED or similar lighting (140) connected to the inner surface of the handle (120) facing the back of the seat (200) and the seat connecting body (130) where the light emitted from this lighting (140) is reflected so as to increase the interior aesthetics of the vehicles used in passenger transportation and for passengers to easily see the handle (120) in the dark. The ambience illuminated handle (100) shown in FIG. 2 comprises; cover (110) which hides connecting elements (121) and lighting (140); handle (120) that hides lighting (140); and seat connection body (130) reflecting illumination (140). The handle connection threads (111), which engage the slots in the handle (120), are positioned on the inner surface of said cover (110), which is connected to the handle (120). The connecting elements (121), which are attached from the outer surface of said handle (120) facing the interior of the vehicle, provide the connection of the handle (120) with the seat (200). There are seat connecting threads (122) on the inner surface of the handle (120) facing the seat (200) that are connected to the seat (200) by passing through the handle slot (131) in the seat connecting body (130) through which the connecting elements (121) pass.

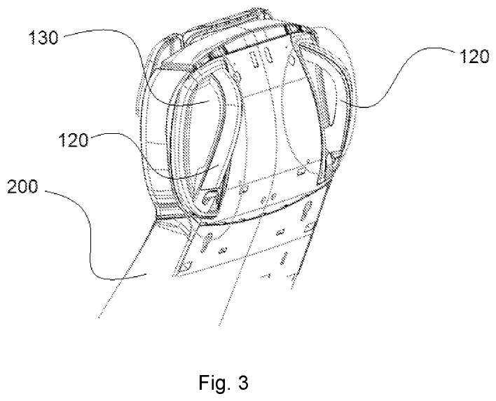

In order to mount the ambience illuminated handle (100) shown in FIG. 3 to the vehicle, firstly, the electrical part of the lighting (140) is processed on the body of the handle (120), then after finishing touches are done for the handle (120) which is mounted in the handle slot (131) placed in the backrest of the seat (200), the cover (110) is placed and mounted and the assembly part is completed. The operation logic of the ambience illuminated handle (100) will make it easier for a person moving in the corridor to grasp where to hold, with the help of the light on the handles (120), while it offers a more luxurious use for the user, it will increase the desire to buy because it is a beautiful design for the customer.

I claim:

1. An ambient illuminated handle that is developed to be used in passenger seats in all vehicles used for passenger transportation, especially in M1, M2, M3, VIP travel buses and minibuses, and rail system, increases vehicle design and comfort, the ambience illuminated handle comprising lighting connected to a handle so that the passengers can easily see the handle in the dark and to increase the interior aesthetics of the vehicles used in passenger transportation.

2. The ambience illuminated handle according to claim 1, wherein the lighting is a LED connected to an inner surface of the seat facing a backrest.

3. The ambience illuminated handle according to claim 1, comprising a seat connecting body that reflects the light emitted from the lighting.

4. The ambience illuminated handle according to claim 3, comprising a handle slot placed on the backrest of the seat, into which the handle is mounted.

5. The ambience illuminated handle according to claim 1, comprising a cover that hides connecting elements and the lighting.

6. The ambience illuminated handle according to claim 5, comprising a handle connecting thread positioned on the inner surface of the cover connecting to the handle, which engages slots on the handle.

7. The ambience illuminated handle according to claim 1, wherein the handle hides the lighting.

8. The ambience illuminated handle according to claim 8, comprising connecting elements that are attached from the outer surface of the handle facing the interior of the vehicle to connect the handle and the seat.

9. The ambience illuminated handle according to claim 8, comprising seat connecting threads on the inner surface of the handle facing the seat that are connected to the seat by passing through a handle slot in a seat connecting body through which the connecting elements pass.
